(19) United States
(12) Patent Application Publication
(10) Pub. No.: US 2017/0106696 A1
(43) Pub. Date: Apr. 20, 2017

(54) CASTOR FOR MOVABLE OBJECTS

(71) Applicant: AS Rollen GmbH, Hueckeswagen (DE)

(72) Inventor: Arnolf SCHULTE, Wermelskirchen (DE)

(73) Assignee: AS Rollen GmbH, Hueckeswagen (DE)

(21) Appl. No.: 15/278,118

(22) Filed: Sep. 28, 2016

(30) Foreign Application Priority Data
Oct. 19, 2015 (DE) 10 2015 013 415.9

(51) Int. Cl. B60B 33/00; A47C 17/86

(52) U.S. Cl. CPC B60B 33/0081; A47C 17/86

(57) ABSTRACT

A castor for movable objects, in particular a bed castor, at least includes a running wheel, a fork receiving the same one, a guiding tube which is swiveling with respect to the fork via at least one bearing, a lock provided on the side of the fork as well as a brake system which is rotation-proof and can be operatively connected to the running wheel. The brake system includes an essentially cylindrical fixing element which is profiled on one side and can be operatively connected to a polygonal safety element on the side of the fork for forming the rotation lock.

### CROSS REFERENCE TO RELATED APPLICATIONS

Applicant claims priority under 35 U.S.C. §119 of German Application No. 10 2015 013 415.9 filed Oct. 19, 2015, the disclosure of which is incorporated by reference.

### BACKGROUND OF THE INVENTION

1. Field of the Invention

The invention relates to a castor for movable objects, in particular a bed castor.

2. Description of the Related Art

DE 10 2010 035 515 A1 discloses a castor for movable objects, in particular a bed castor, which at least comprises a running wheel, a fork receiving the same one, a guiding tube which is swiveling with respect to the fork via at least one bearing, a brake system, which is composed of at least one brake lever and a fixing element positioned within the guiding tube, and which can be operatively connected to the running wheel, as well as locking means provided on the side of the fork, wherein for fixing the fork with respect to the guiding tube, the locking means provided with profiles can be operatively connected to each other by actuating the fixing element, such that a locking essentially without backlash between the fork and the guiding tube is achieved.

The fixing element guided within a stud is hexagonal, wherein the stud is provided with a similar inner contour in the guiding area. A rotation lock is formed in the hexagonal guiding area between the stud and the fixing element. This type of rotation lock, which has been used for decades, requires a complex manufacturing process, since at least the inner contour of the stud has to be turned, on the one hand, and be burnished, on the other hand. Wear resistant coatings which have to be applied also cause problems. Already small tolerance deviations in the guiding area provoke undesired angular deflections of the running wheel. One more problem of this design is also the use of plastic components.

### SUMMARY OF THE INVENTION

It is the object of the subject of invention to provide an alternative rotation lock, which is different from the state of the art, for running wheels of most varied designs, which rotation locks do no more comprise the above described disadvantages.

This aim is achieved by a castor for movable objects, in particular a bed castor, which at least comprises a running wheel, a fork receiving the same one, a guiding tube which is swiveling with respect to the fork via at least one bearing, locking means provided on the side of the fork as well as a brake system which is rotation-proof and can be operatively connected to the running wheel, wherein the brake system comprises an essentially cylindrical fixing element which is profiled on one side and can be operatively connected to a polygonal safety element on the side of the fork for forming the rotation lock.

Advantageous embodiments of the subject of invention are disclosed below.

Departing from the state of the art, an alternative rotation lock is thus provided, which can be realized by means of simple components which can also be made of plastic. Due to the large area proportions of the profile/safety element provided on the fixing element, tolerance-related differences have no more the same effects as in the state of the art. The safety element can be preferably triangular or quadrangular.

A special embodiment of the subject of invention provides that the safety element is designed like a hexagonal nut. It is thus possible to use customary components here.

According to another aspect of the invention, the profile provided on the fixing element essentially corresponds to the outer contour of the safety element, wherein the profile at least partially overlaps the safety element in the installed condition.

According to another aspect of the invention, the fixing element can be guided inside a stud which is provided with a cylindrical bore, wherein a sliding element can be provided between the bore and the outer circumferential surface of the cylindrical fixing element.

This sliding element which is designed like a sleeve can be made, if required, of plastic, in particular of PTFE.

### BRIEF DESCRIPTION OF THE DRAWINGS

The subject of invention is represented in the drawing by means of an exemplary embodiment and is described as follows.

In the drawing:

FIG. 1 shows a schematic diagram of a castor for movable objects,

FIG. 2 and FIG. 3 show different views of the fork according to FIG. 1 with a represented rotation lock.

### DETAILED DESCRIPTION OF PREFERRED EMBODIMENTS

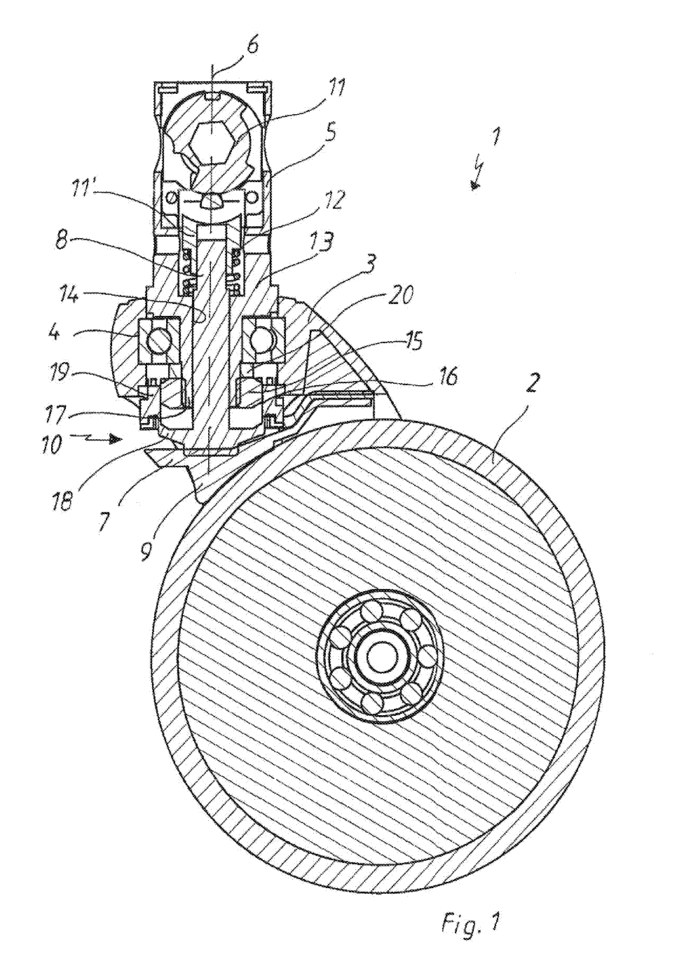

FIG. 1 shows a castor 1 according to the invention, the structure of which approximately corresponds to the one of DE 10 2010 035 515 A1.

The following components are visible: a running wheel 2, a fork 3 receiving the same one, which fork can be swiveled around a vertical axis 6 via a roller bearing 4 with respect to a guiding tube 5. A brake system composed of at least one brake lever 7 and a fixing element 8 positioned inside the guiding tube 5 can be operatively connected to the running wheel 2. In the area of its free end 9 the brake lever 7 can be fixed outside the running wheel 2 on the end portion 10 of the fixing element 10 on the side of the fork. The fixing element 8 can only be displaced in the vertical direction with respect to the stationary guiding tube 5 via an eccentric 11, which is designed like a hexagonal eccentric in this example, as well as via an eccentric pressure piece 11′ which is operatively connected to the eccentric, such that the brake lever 7 is either pressed on the running wheel 2 or can be removed from the same one. Herein, the eccentric pressure piece 11′ is firmly connected, for example by means of screwing, to the one end of the fixing element 8 and serves as supporting surface for a spring element 12. On the side of the fork, the guiding tube cooperates with a stud 13 which also receives the roller bearing 4. The fixing element 8, which is cylindrical in this example, is guided inside an also cylindrical bore 14 of the stud 13.

For forming a rotation lock, the following components are given: on the one hand, a safety element 15, which is designed like a hexagonal nut in this example, including an outer contour 16 which is screwed in a rotation-proof manner on the free end 17 of the stud 13. Instead of the hexagonal nut, it is also possible to use a triangular, quadrangular or pentagonal body. If required, an adhesive can also be used here, in order to thus improve the rotation resistance.

A profile 18 is moulded on the end of the fixing element 8, which end is facing the running wheel 2. The free end portion 19 of the profile 18 overlaps essential surfaces of the hexagonal nut 16 in the axial direction. Departing from the state of the art, an alternative rotation lock having a simple construction is thus provided. If required, the fixing element 3 can also be manufactured as injection moulded part made of plastic.

Although not represented here, it is imaginable in certain cases to provide a slide bearing between the bore 14 and the fixing element 8. In order to be able to compensate height tolerances, a washer 20 can be provided, in case of need, between the roller bearing 4 and the hexagonal nut 16.

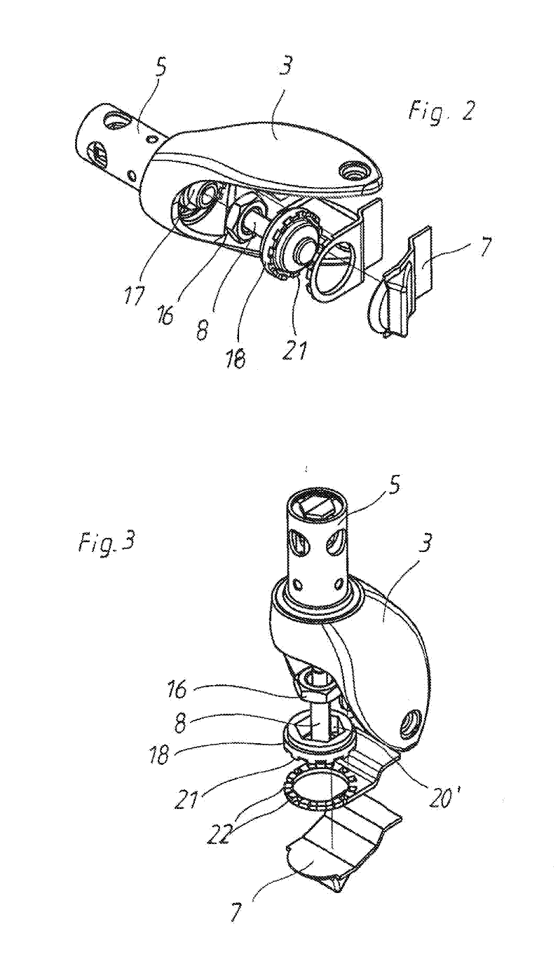

FIGS. 2 and 3 show different views of the fork 3 including the guiding tube 5 in operative connection with the rotation lock described with respect to FIG. 1. The following components are visible: the free end 17 of the stud, which is not visible here, the hexagonal nut 16 which can be screwed on this free end 17, the cylindrical fixing element 8, the profile 18 as well as the hexagon socket 20′ of the profile 18, which can at least partially be slid over the hexagonal nut 16 for forming the rotation lock.

Tooth elements 21 are furthermore provided on the profile 18, which tooth elements engage into a counter-profile 22 which cooperates with the brake lever 7, wherein the running wheel will be fixed after having actuated the brake.

Although only a few embodiments of the present invention have been shown and described, it is to be understood that many changes and modifications may be made thereunto without departing from the spirit and scope of the invention.

### LIST OF REFERENCE NUMERALS

1 castor

2 cunning wheel

3 fork

4 roller bearing

5 guiding tube

6 axis

7 brake lever

8 fixing element

9 free end

10 end portion

11 eccentric

11′eccentric pressure piece

12 spring element

13 stud

14 bore

15 hexagonal nut (safety element)

16 outer contour

17 free end

18 profile

19 end portion+

20 washer

20′hexagon socket

21 tooth clement

22 counter-profile

What is claimed is:

1. A castor for movable objects, in particular a bed castor, which at least comprises a running wheel (2), a fork (3) receiving the same one, a guiding tube (5) which is swiveling with respect to the fork (3) via at least one bearing (4), locking means provided on the side of the fork as well as a brake system (7) which is rotation-proof and can be operatively connected to the running wheel (2), wherein the brake system (7) comprises an essentially cylindrical fixing element (8) which is profiled on one side and can be operatively connected to a polygonal safety element (15) on the side of the fork for forming the rotation lock.

2. A castor according to claim 1, wherein the safety element (15) is triangular.

3. A castor according to claim 1, wherein the safety element (15) is quadrangular.

4. A castor according to claim 1, wherein the safety element (15) is designed like a hexagonal nut.

5. A castor according to claim 1, wherein the profile provided on the fixing element (8) essentially corresponds to the outer contour of the safety element (15).

6. A castor according to claim 1, wherein the profile (18) at least partially overlaps the safety element (15) in the installed condition.

7. A castor according to claim 1, wherein the fixing element (8) made of plastic is guided inside a stud (13) which is provided with a cylindrical bore (14), wherein a sliding element is provided between the bore (14) and the outer circumferential surface of the cylindrical fixing element (3).

8. A castor according to claim 7, wherein the sliding element which is designed like a sleeve is made of plastic, in particular of polytetrafluoroethylene (PTFE).
